(19) United States
(12) Patent Application Publication
(10) Pub. No.: US 2020/0269532 A1
(43) Pub. Date: Aug. 27, 2020

(54) SILICONE BASED EXPANDABLE TIRE CURING BLADDER

(71) Applicant: LANG YUZER OTOMOTIV YAN SANAYI VE TICARET ANONIM SIRKETI, Tekirdag (TR)

(72) Inventor: Ismet YUZER, Tekirdag (TR)

(73) Assignee: LANG YUZER OTOMOTIV YAN SANAYI VE TICARET ANONIM SIRKETI, Tekirdag (TR)

(21) Appl. No.: 16/066,304

(22) PCT Filed: Dec. 30, 2015
(86) PCT No.: PCT/TR2015/000393

§ 371 Date: Jun. 27, 2018

(51) Int. Cl. B29D 30/06; C08G 77/08; C08J 3/22

(52) U.S. Cl. CPC B29D 30/0654; B29C 2043/3649; C08J 3/22; C08G 77/08

(57) ABSTRACT

A Silicon based expandable curing bladder comprising, an expandable tire curing bladder (20) composition comprising a silicone base at least 50 to 99 percent by weight of the composition. The curing bladder (20) comprising a silicon base and/or additives which are selected from the groups consisting of silicon base rubber, silicon base compound, silicone color, platinum catalyst, inhibitor, activator, heat stabilizers, crosslinkers and filler in order to increase release properties of an expandable curing bladder with long durability. A production method which is preferably compression and/or transfer molding or injection molding is also described accordingly.

### TECHNICAL FIELD

Invention relates to expandable tire curing bladders and manufacture of tires using the same.

### PRIOR ART

In manufacturing tires, the actual shaping of the tire is caused by inflating a rubber bag inside a green tire carcass to force the tire into shape within the mold.

Curing is one of the production processes of the pneumatic tire manufacturing by use of an expandable bladder. A green tire construct is previously prepared and subsequently placed in a tire curing mold where the tire is cured to have outer geometry such as thread patterns. In order to tire to be shaped, uncured tire expanded outwardly against the mold surface to ensure a proper contact. Expansion amount is usually 1.5-2% of the initial volume for large sized molds. Bladders are used to expand and cure tire construct inside the curing mold. Generally, there is substantial movement between the outer contact surface of the bladder and the inner surface of the green tire during the expansion phase of the bladder prior to fully curing the tire. Likewise, there is considerable relative movement between the outer contact surface of the bladder and the cured inner surface of the tire after the tire has been molded and vulcanized during the collapse and the stripping of the bladder from the tire.

Known applications advise use nitrogen, hot water or steam to heat and expand bladders in order to exert pressure to the tire from the bladder. Heat transfer from bladder to tire support curing process inside the mold. Cooling fluid, such as cold water provided through the bladder before opening the mold.

Insufficient lubrication between the bladder and tire may cause sticking and cured tire to be damaged during removal of the bladder from the tire. In some cases, damage may lead to cured tires to be scrapped. In fully automated tire presses, loading the next tire before successful removal of the previous one due to the sticking damage not only damaged tire but harm next operation.

US2013087953A1 disclose a curing bladder comprising an elastomeric composition comprising 100 parts by weight of elastomer, a curative, and from 1 phr to 50 phr of a hydrocarbon polymer modifier, wherein the elastomer comprises at least one isobutylene based elastomer, wherein the hydrocarbon polymer modifier comprises monomers selected from the group consisting of piperylenes, cyclic pentadienes, aromatics, limonenes, pinenes, amylenes, and combinations thereof, and wherein the cyclic pentadienes comprise at least 10 weight percent of the monomers by total weight of the monomers.

It is desired that such a bladder for tire vulcanization is superior in physical and chemical properties such as mechanical properties and steam resistance and also in durability, separability, and processability. However, mainly, butyl rubbers have been used as the material for such a bladder proposed for improvement of durability

### SUMMARY OF THE INVENTION

The object of the invention is increase release properties of an expandable curing bladder with long durability.

The invention enables to obtain a bladder with an improved set of physical and mechanical properties and processability owing to low adhesion of the initial bladder composition. It is essential that there be sufficient release force between the bladder and the inner surface of the tire in order to allow optimum slip of the bladder during the shaping process when the raw tire and bladder are in friction with one another.

Another object of the invention is to improve heat transfer properties of a tire curing process with an improved expandable curing bladder.

In order to achieve above objectives, preferred embodiment of the invention is an expandable tire curing bladder composition comprising a silicone base at least 50 to 99 percent by weight of the composition. Silicon base of selected amount prevent sticking of the bladder to the tire after curing is completed. Silicon intensive composition increases resistance to the hot steam temperature which is used to expand the bladder and a lower bladder thickness comparing with bladders made of other elastomers, e.g. isobutylene is possible due to the increased heat transfer efficiency. In a preferred embodiment, the silicon base is less than or equal to 95 and greater than or equal to 90 percent by weight of the composition. Surprisingly, high amount of silicon compound of the composition provide all required mechanical properties and a satisfactory service life. In another preferred embodiment, the composition further comprises at least one of the additive compounds selected from a group of an activator batch, an inhibitor batch and a heat stabilizer batch at least 1 percent by weight of the composition. Additives further enhance mechanical properties of the bladder. In a preferred embodiment, the activator batch is 1 percent by weight of the composition. Preferably, the inhibitor batch is 0.5 percent by weight of the composition. The heat stabilizer batch is 1 percent by weight of the composition. Preferably, composition further comprises a silicone color batch black, 2 percent by weight of the composition.

A preferred embodiment of bladder composition comprising a silicon base selected from the group of solid silicone rubber, liquid silicone rubber, 2-part silicone rubber, silicone rubber, silicone gels or mixtures. The compound or compounds of the curing bladder comprising a silicon base and/or additives selected from the groups consisting of silicon base rubber, silicon base compound, silicone color, platinum catalyst, inhibitor, activator, heat stabilizers, crosslinkers and filler.

Preferably, composition further comprises an activator batch, 1 percent by weight of the composition. Preferably, composition further comprises a platen catalyst batch, 0.5 percent by weight of the composition. In order to achieve above mentioned objectives, invention comprises the production method steps of, mixing silicon base and additive compounds of a composition, heating the composition and forming a curing bladder by means of injection molding.

The silicone base of the invention is commercially available silicone rubbers. They are made by cross-linking of cross-linkable silicone compositions. Such silicone compositions are preferably selected from the group consisting of condensation, addition and peroxide curing silicone compositions. Also, the use of cross-linking by radiation (for example UV) silicone compositions is possible. According to invention, curable silicone compositions at room temperature can be chosen for the heat curing

### BRIEF DESCRIPTION OF THE DRAWINGS

FIG. 1 is a cross-section view of an exemplary tire curing mold having subject matter expandable curing bladder.

REFERENCE NUMBERS

| | |
|---|---|
| 10 Uncured tire | 12 Inner wall |
| 14 Outer wall | 20 Expandable bladder |
| 22 Outer wall | 24 Inner wall |
| 30 Curing mold | 32 Upper halve |
| 34 Lower halve | 40 Heating fluid inlet |
| 50 Curing chamber | |

### THE DETAILED DESCRIPTION OF THE INVENTION

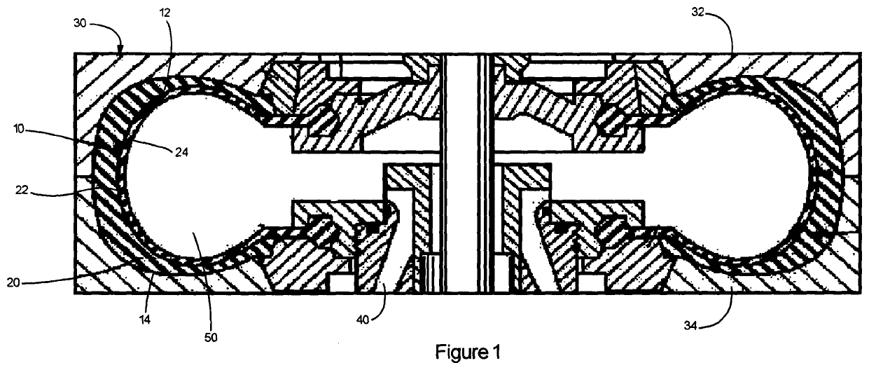

In FIG. 1, a standard curing mold (30) where an uncured tire (10) construct is arranged is shown in cross-sectional view. The curing mold (30) have two separable halves, namely upper halve (32) and lower halve (34). Upper halve (32) can be raised, lowered and tilted. In the central region of the curing mold (30) a curing chamber (50) is formed in toroid cavity shape. A green, uncured tire (10) comprises a radially inwardly facing inner wall (12) and an opposite facing outer wall (14). An expandable bladder (20) with a composition comprises 95% of total weight silicone base is arranged inside the uncured tire (10). A heating fluid inlet (40) is provided at the lower halve (34) of the curing mold (30). The heating fluid inlet (40) is in communication with the curing chamber (50). A how steam as heating fluid fed through the inlet (40) fill out the inner cavity of the expandable bladder (20) and create pressure at the inner wall (24) of the expanding bladder (20). The expandable bladder (20) press against the uncured tire (10) from the inner wall (12) and increase inner volume 1.5-2% inside the curing mold (30) with rigid curing chamber (50). The hot steam applied towards the inner wall (24) increases the temperature at the expandable bladder (20) and transfer heat to the uncured tire (10) to support curing process. An example composition of the silicon expandable bladder (20) is shown at the table below. Composition of the expandable bladder (20) allows use of lower thickness comparing with the isobutylene products. Therefore, heat transfer efficiency is increased. It has been therefore the task of silicone rubbers in an easily processable form to provide, so that they can be applied and fixed by means of simple methods and without the need for complex manufacturing systems on various surfaces.

In one embodiment, after the silicone base, the hydrogenation catalyst is added. The examples which follow serve to illustrate the invention. Parts and percentages are by weight, unless otherwise stated. Parts by weight relate to parts by volume as the kilogram relates to the liter. Silicones are made from quartz sand, a raw material available in practically unlimited quantities.

The silicone base is main component of the inventive bladder composition and which can be chosen as silicon rubber. Unvulcanized(Uncured) silicone rubber contains polymers of different chain length or polysiloxane chains. These polysiloxane chains always have a silicon-oxygen backbone. A silicon atom has four valence electrons, which is why silicone rubber is often abbreviated with a Q for “quaternary group”. The properties of silicone rubber vary greatly depending on the organic groups and the chemical structure. The organic groups may be methyl, vinyl, phenyl or other groups. Depending on which organic groups are present. For example, polydimethylsiloxane denotes a polymer in which two methyl groups are bound to the siloxane backbone. Some polydimethylsiloxane base components comprising vinyl groups or phenyl groups or trifluoropropyl substituents which of can be replaced with small number of methyl group of the polydimethylsiloxane.

Two organic side-groups—usually methyl—are attached to each silicon atom. The polysiloxane chains determine the essential material properties possessed by all silicone rubbers such as heat resistance and electrical characteristics. Uncrosslinked silicone rubber needs to be vulcanized to convert it into an elastomer. There can be applied one of the crosslinking process which is classified platinum-catalyzed addition curing, peroxide curing and condensation curing. All three types of crosslinking have advantages. During platinum-catalyzed addition curing, the crosslinker's Si—H groups react with the vinyl groups of the polymer to form a three-dimensional network.

Silicone rubbers can be converted into silicone elastomers by vulcanization (curing). They are classified according to the curing method, the viscosity of the base polymer, and whether they cure at high or room temperature. Bladder composition comprising a silicon base selected from the group of solid silicone rubber, liquid silicone rubber, 2-part silicone rubber, silicone rubber, silicone gels or mixtures thereof. Solid silicone rubber contains polymers with a high molecular weight and relatively long polymer chains and they are high-temperature-vulcanizing. Liquid silicone rubber contains polymers of lower molecular weight and hence shorter chains. It has better flow properties. Liquid silicone rubber is always addition-curing (like platinum-catalyzed or crosslinker). Uncured silicone rubber generally contains only three additional substances: crosslinker, fillers and additives. A crosslinker is required to convert the raw rubber into a mechanically stable cured product. Use is made of peroxides or platinum catalyst systems

Fillers are needed to reinforce the elastic silicone network. The nature, composition and quantity of the fillers have a crucial influence on the properties of the raw and cured rubber.

A bladder composition comprising liquid silicone rubbers products are two-part silicone rubber grades (50:50), which can be fully automatically injection molded without secondary processing. Other additives are used together with our silicone rubber grades, for example as primers and adhesion promoters for perfect adhesion; or as mold release agents for problem-free demolding of parts.

Silicone base of the present invention is characterized by its ease of processing. Most applications of preferred embodiments involve the step of use of additives. The compounding components of the present inventions are blended in the following order preferably: silicone rubber, stabilizers, colorant, crosslinker. In the case of nonready-to-process solid silicone rubber grades, crosslinker and any other necessary additives, stabilizers or pigment pastes are blended in on the roll mill. The production steps of the preferable embodiment of the inventive bladder comprises roll mills which is used than under temperature controlled such as water cooling and friction should be arranged for example about 1:1.2. Another embodiment of the present invention for particularly bladder applications, special properties of solid silicone rubber can be further enhanced by the addition of stabilizers and other additives. Preferably, the silicone rubber is homogenized for 2 to 10 minutes before incorporating paste additive. In the preferred embodiment of the present invention heat stabilizers are used preferably between 225° C. and 300° C. Since the bladder will be exposed to extremely high temperatures need to be heat-stabilized. Special oxides of transition metals (e.g. iron) and special carbon blacks are particularly suitable for this purpose. The correct choice of stabilizer depends on the crosslinker, color and operating temperature. Some additives cause a slight brown discoloration of the cured rubber product under the influence of thermal aging. Therefore, in the preferred embodiment preferably colored compounds are used. Another embodiment of the invention, reversion stabilizers are used to prevent blooming effect on the surface of non-post cured rubber products by binding. Another embodiment of the invention, mastication aids is used. Another embodiment of the invention, mold release agents is used. Other additives can be for flame resistance or foam batches. A homogeneously colored material will then indicate uniform crosslinker distribution by adding the pigment pastes together with the crosslinker. Furthermore, also stirring the mix provides homogenize color. In the present invention, platinum-catalyzed addition to curing compound for the preferred applications provides that odorless production and non-volatile peroxide by-products are released. Transparent articles do not discolor during post-curing, curing is fast and cycle times therefore short, The cured product is readily demoldable and has a dry surface. If the silicone base is 1 part compound as a ready to process compound, there the platinum catalyst mostly exist in the rubber formulation. In 2-part system, the catalyst is added later

### Example 1

The preferred bladder composition in embodiment of present invention is made from a mixture comprising greater than or equal to 80% to less than or equal to 99.9% silicone base components, and from 1% to 20% additives. The additive mixture may optionally comprise up to 5% activator batch, up to 1% catalyst batch, up to 1% inhibitor batch, up to 5% heat stabilizers batch, up to 1% crosslinkers batch, up to 5% color batch, up to 5% filler batch, up to 5% other components, or any combination thereof. Preferably, in an embodiment, the bladder composition comprises from 85% to 97% silicone base component most preferably from 90% to 97% silicone base component, more preferably 95%.

TABLE 1
Composition Formula

| Compound | Percentage by weight (%) |
|---|---|
| Silicone Base | between 80-99.9 |
| Color batch | between 0-5 |
| Catalyst - Batch | between 0-1 |
| Inhibitor Batch | between 0-1 |
| Activator-Batch | between 0-5 |
| Heat Stabilizers-Batch | between 0-5 |
| Crosslinkers | between 0-1 |
| Filler | between 0-5 |
| Other additives(mold release agents | between 0.1-5 |
| and/or flame resistance and/or foam | |
| batches and/mastica aids) | |

### Example 2

The alternative bladder composition in embodiments is preferably made from a mixture comprising from 50% to 99.9% silicone base components, and from 1% to 10% additives. The additive mixture may optionally comprise up to 5% activator batch, up to 1% catalyst batch, up to 1% inhibitor batch, up to 5% heat stabilizers batch, up to 1% crosslinkers batch, up to 5% color batch, up to 5% filler batch, up to 5% other components, or any combination thereof. Alternatively or additionally, in an embodiment, the bladder composition comprises from 0% to 50% rubber composition preferably from 0% to 33% organic rubber components, more preferably less than 0.05%,

TABLE 2
Composition Formula

| Compound | Percentage by weight (%) |
|---|---|
| Silicone Base | between 50-99.9 |
| rubber composition | between 0-45 |
| color batch | between 0-5 |
| Catalyst - Batch | between 0-1 |
| Inhibitor Batch | between 0-1 |
| Activator-Batch | between 0-5 |
| Heat Stabilizers-Batch | between 0-5 |
| Crosslinkers | between 0-1 |
| Filler | between 0-5 |
| Other additives(mold release agents | between 0.1-5 |
| and/or flame resistance and/or foam | |
| batches and/mastica aids) | |

### Example 3

The bladder composition in embodiments is preferably made from a mixture comprising from 50% to 99.9% silicone base components, and from 1% to 10% additives. The additive mixture may optionally comprise up to 5% activator batch, up to 1% platinum catalyst batch, up to 1% inhibitor batch, up to 5% heat stabilizers batch, up to 1% crosslinkers batch, up to 5% silicon color batch black, up to 5% filler batch, up to 5% other components, or any combination thereof. The cited color black is can be chosen in different color.

TABLE 2
Composition Formula

| Compound | Percentage by weight (%) |
|---|---|
| Silicone Base | between 50-99 |
| Silicone color batch black | up to 2 |
| Platinum Catalyst - Batch | up to 0.5 |
| Inhibitor Batch | up to 0.5 |
| Activator-Batch | up to 1 |
| Heat Stabilizers-Batch | up to 1 |
| Crosslinkers | up to 1 |
| Filler | up to 5 |
| Other additives(mold release agents | up to 0.1 |
| and/or flame resistance and/or foam | |
| batches and/mastica aids) | |

### Example 4

The bladder composition in embodiments is preferably made from a mixture comprising from 90% to 97% silicone base components, and from 3% to 10% additives. The additive mixture may optionally comprise up to 1% activator batch, up to 0.5% platinum catalyst batch, up to 0.5% inhibitor batch, up to 1% heat stabilizers batch, up to 2% silicone color batch black components, or any combination thereof.

TABLE 4
Composition Formula

| Compound | Percentage by weight (%) |
|---|---|
| Silicone Base | 90-97 |
| Silicone color batch black | up to 2 |
| Platinum Catalyst - Batch | up to 0.5 |
| Inhibitor Batch | up to 0.5 |
| Activator-Batch | up to 1 |
| Heat Stabilizers-Batch | up to 1 |

### Example 5

The bladder composition in embodiments is preferably made from a mixture comprising 95% silicone base components, and preferably 5% additives. The additive mixture may optionally comprise preferably 1% activator batch, preferably 0.5% platinum catalyst batch, preferably 0.5% inhibitor batch, preferably 1% heat stabilizers batch, preferably 2% silicone color batch black components, or any combination thereof.

TABLE 5
Composition Formula

| Compound | Percentage by weight (%) |
|---|---|
| Silicone Base | 95 |
| Silicone color batch black | 2 |
| Platinum Catalyst - Batch | 0.5 |
| Inhibitor Batch | 0.5 |
| Activator-Batch | 1 |
| Heat Stabilizers-Batch | 1 |

### Example 6

The bladder composition in embodiments is preferably made from a mixture comprising 90% silicone base components, and preferably 10% additives. The additive mixture may optionally comprise preferably 1% activator batch, preferably 0.5% platinum catalyst batch, preferably 0.5% inhibitor batch, preferably 1% heat stabilizers batch, preferably 2% silicone color batch black components, or any combination thereof.

TABLE 6
Composition Formula

| Compound | Percentage by weight (%) |
|---|---|
| Silicone Base | 90 |
| color batch | 2 |
| Catalyst - Batch | 0.5 |
| Inhibitor Batch | 0.5 |
| Activator-Batch | 1 |
| Heat Stabilizers-Batch | 1 |

### Example 7

The bladder composition in embodiments is preferably made from a mixture comprising 97% silicone base components, and preferably 3% additives. The additive mixture may optionally comprise preferably 1% activator batch, preferably 0.5% platinum catalyst batch, preferably 0.5% inhibitor batch, preferably 1% heat stabilizers batch, preferably 2% silicone color batch black components, or any combination thereof.

TABLE 7
Composition Formula

| Compound | Percentage by weight (%) |
|---|---|
| Silicone Base | 97 |
| color batch | 2 |
| Catalyst - Batch | 0.5 |
| Inhibitor Batch | 0.5 |
| Activator-Batch | 1 |
| Heat Stabilizers-Batch | 1 |

The preferred production method of the inventive tire curing bladder comprising solid silicone rubber having the steps of metering, mixing silicon base and additive compounds of a composition, heating the composition and, injecting/forming a curing bladder and having pot live prevent premature vulcanization by injection molding which allows shorter production cost. The preferred production method of the inventive tire curing bladder comprising solid silicone rubber having the steps of mold filling with silicon base and additive compounds of a composition, pressing/vulcanization of the composition and demolding a curing bladder. The preferred process choice of the bladder is selected the process group of extrusion, coextrusion, compression molding, transfer molding, injection molding, blade calendaring when the silicone base comprising solid silicon rubber. The preferred process choice of the bladder is selected the group of injection molding, blade and low pressure filling when the silicone base comprising liquid silicon rubber. For injection molding, For compression molding, peroxidecuring and platinum-catalyzed and solid silicone rubber grades are preferred. The preferred process comprising presses are usually hydraulically operated, they are heated, e.g. electrically or with steam. For vulcanization of peroxide mixtures with crosslinkers, and for platinum-catalyzed solid silicone rubber, a mold temperature of about 150 to 200° C. is preferably chosen. These temperatures do not limit another embodiment and alternative embodiments of the present invention. The temperature plays an important role: it is required to be as high as possible to shorten the vulcanizing time and therefore the cycle times. Moreover, temperature has to be at the proper maximum level that not cause to scorching. The vulcanizing time is determined by the temperature of the composition, the mold temperature and the thickness of the part. External and internal mold-release agents can be used to assist demolding.

Ideally, silicone rubber articles do not need secondary finishing. But in the alternative embodiment of the present invention the bladder composition must be post-cured. That involves heating at a high temperature for a defined time.

What is claimed is:

1. An expandable tire curing bladder, wherein a composition of the expandable tire curing bladder comprises a silicone base, a weight percentage of the silicone base is at least 50 to 99 percent.

2. The expandable tire curing bladder according to claim 1, wherein the weight percentage of the silicon base is ranging from 90 to 95 percent.

3. The expandable tire curing bladder according to claim 1, wherein the silicon base is selected from the group consisting of solid silicone rubber, liquid silicone rubber, 2-part silicone rubber, silicone rubber, silicone gel and a mixture of solid silicone rubber, liquid silicone rubber, 2-part silicone rubber, silicone rubber, silicone gel.

4. The expandable tire curing bladder according to claim 1, wherein a compound or compounds of the expandable tire curing bladder comprises the silicon base and/or additives, the additives are selected from the group consisting of silicon base rubber, silicon base compound, silicone color, platinum catalyst, inhibitor, activator, heat stabilizers, crosslinkers and filler.

5. The expandable tire curing bladder according to claim 1, wherein the composition further comprises at least one of additive compounds in a weight percentage of at least 1 percent, the additive compounds are selected from the group consisting of an activator batch, an inhibitor batch and a heat stabilizer batch.

6. The expandable tire curing bladder according to claim 3, wherein a weight percentage of an activator batch is less than or equal to 1 percent.

7. The expandable tire curing bladder according to claim 3, wherein a weight percentage of an inhibitor batch is less than or equal to 0.5 percent.

8. The expandable tire curing bladder according to claim 3, wherein in a weight percentage of a heat stabilizer batch is less than or equal to 1 percent.

9. The expandable tire curing bladder according to claim 1, wherein the composition further comprises a silicone color batch, a weight percentage of the silicone color batch is 2 percent.

10. The expandable tire curing bladder according to claim 1, wherein the composition further comprises an activator batch, a weight percentage of the activator batch is less than or equal to 1 percent.

11. The expandable tire curing bladder according to claim 1, wherein the composition further comprises a platen catalyst batch, a weight percentage of the platen catalyst batch is less than or equal to 0.5 percent.

12. A production method of an expandable tire curing bladder, wherein a composition of the expandable tire curing bladder comprises a silicone base, a weight percentage of the silicone base is at least 50 to 99 percent; and
the production method comprises the steps of mixing the silicon base and additive compounds to obtain the composition, heating the composition and forming the expandable tire curing bladder through an injection molding.

13. A production method of an expandable tire curing bladder, wherein a composition of the expandable tire curing bladder comprises a silicone base, a weight percentage of the silicone base is at least 50 to 99 percent; and
the production method comprises steps of filling the silicon base and additive compounds to obtain the composition, pressing/vulcanization of the composition and demolding the expandable tire curing bladder through compression and/or transfer molding.

14. The expandable tire curing bladder according to claim 2, wherein the composition further comprises at least one of additive compounds in a weight percentage of at least 1 percent, the additive compounds are selected from the group consisting of an activator batch, an inhibitor batch and a heat stabilizer batch.

15. The expandable tire curing bladder according to claim 3, wherein the composition further comprises at least one of additive compounds in a weight percentage of at least 1 percent, the additive compounds are selected from the group consisting of an activator batch, an inhibitor batch and a heat stabilizer batch.

16. The expandable tire curing bladder according to claim 4, wherein the composition further comprises at least one of additive compounds in a weight percentage of at least 1 percent, the additive compounds are selected from the group consisting of an activator batch, an inhibitor batch and a heat stabilizer batch.

17. The expandable tire curing bladder according to claim 2, wherein the composition further comprises a silicone color batch, a weight percentage of the silicone color batch is 2 percent.

18. The expandable tire curing bladder according to claim 3, wherein the composition further comprises a silicone color batch, a weight percentage of the silicone color batch is 2 percent.

19. The expandable tire curing bladder according to claim 4, wherein the composition further comprises a silicone color batch, a weight percentage of the silicone color batch is 2 percent.

20. The expandable tire curing bladder according to claim 5, wherein the composition further comprises a silicone color batch, a weight percentage of the silicone color batch is 2 percent.
